(19) United States
(12) Patent Application Publication
(10) Pub. No.: US 2023/0356891 A1
(43) Pub. Date: Nov. 9, 2023

(54) Sealable Hatch Assembly Including Seal Member And Related Methods

(71) Applicant: Electromechanical Research Laboratories, Inc., New Albany, IN (US)

(72) Inventors: Stephen P. Wilkins, Floyds Knobs, IN (US); Ryan Waiz, Georgetown, IN (US)

(21) Appl. No.: 18/142,830

(22) Filed: May 3, 2023

Related U.S. Application Data
(60) Provisional application No. 63/338,123, filed on May 4, 2022.

(51) Int. Cl. B65D 45/24

(52) U.S. Cl. CPC B65D 45/24; B65D 2251/20

(57) ABSTRACT

A sealable hatch assembly may include a hatch lid and an elongated pocket on the interior side of the hatch lid and extending adjacent the perimeter. The elongated pocket may at least partially define a pocket width, and the sealable hatch assembly also may include a seal member received in the elongated pocket. The seal member may be configured to provide an uninterrupted seal between the hatch lid and a hatch extension coupled to the compartment adjacent the opening. The seal member may include an inner seal portion and an outer seal portion at least partially coating the inner seal portion. The inner seal portion may be elastically compressible, and the outer seal portion may be chemically resistant. The seal member may define a cross-section having an uncompressed dimension greater than the pocket width, such that the seal member is at least partially compressed as received in the elongated pocket.

### PRIORITY CLAIM

This U.S. non-provisional patent application claims priority to and the benefit of, under 35 U.S.C. § 119(e), U.S. Provisional Application No. 63/338,123, filed May 4, 2022, “Sealable Hatch Assembly Including Seal Member and Related Methods,” the disclosure of which is incorporated herein by reference in its entirety.

### TECHNICAL FIELD

The present disclosure relates to sealable hatch assemblies and, more particularly, to sealable hatch assemblies and related methods.

### BACKGROUND

Compartments such as containers may be used to store or transport commodities, such as, for example, grain, minerals, and liquids, such as water and petroleum-based products. Such compartments may generally include ports or openings to facilitate transferring materials into the compartment or withdrawing materials from the compartment. It may be desirable, however, to prevent potential contaminates from entering the compartment through the openings and/or material in the compartment from escaping to the surrounding environment from the openings. A hatch may be provided to selectively open and close the opening to facilitate transfer of materials into the compartment in the open position and to seal the compartment from the surrounding environment in the closed position.

Although a hatch may be useful for providing access to the interior of a compartment and closing the compartment, hatches may not provide a sufficient seal between the interior of the compartment and the surrounding environment. This may lead to unintended escape of materials from the interior of the compartment to the surrounding environment or the admission of contaminates to the interior of the compartment from the surrounding environment, neither of which may be desirable in certain instances.

Thus, Applicant has recognized that it may be desirable to provide a hatch assembly and related methods that address one or more of the above-mentioned concerns associated with compartments. As a result, it may be desirable to provide assemblies and methods for selectively and sealably closing openings in compartments to reduce the likelihood or prevent materials inside the compartment from escaping from the compartment and/or to reduce the likelihood or prevent potential contaminates in the surrounding environment from entering the compartment. The assemblies and methods described herein may address one or more possible drawbacks associated with opening and closing openings in compartments as described above, as well as possibly others.

### SUMMARY

As referenced above, it may be desirable to provide a hatch assembly and related methods that address one or more of the above-mentioned concerns associated with opening and closing compartments. In some embodiments, a sealable hatch assembly and related methods may be provided that result in improved sealing of a hatch lid when the hatch lid is in the closed condition, thereby reducing the likelihood or preventing materials inside the compartment from escaping through an opening in the compartment and/or reducing the likelihood or preventing possible contaminants in the surrounding environment from entering the compartment through the opening. A seal member also may be provided, and the seal member may reduce the likelihood or prevent materials, such as, for example, solids, liquids, and/or vapors, inside the compartment from escaping through the opening in the compartment and/or reducing the likelihood or preventing possible contaminants in the surrounding environment, such as, for example, solids, liquids, and/or vapors, from entering the compartment through the opening. The seal member also may provide a chemical-resistant seal, which may result in the seal member having an increased service life relative to other seals. In some embodiments, the sealable hatch assembly and related methods may be used in association with vehicles, such as cargo vehicles including trucks, trains, tankers, ships, and barges.

In some embodiments, a sealable hatch assembly configured to move between an open condition providing access via an opening to an interior of a compartment on which the sealable hatch assembly is disposed to a closed condition in which the access is sealed, may include a hatch lid providing a barrier defining a perimeter, an interior side configured to face an interior of the compartment when in the closed condition, and an exterior side opposite the interior side. The sealable hatch assembly further may include an elongated pocket on the interior side of the hatch lid. The elongated pocket may at least partially define a pocket width. The sealable hatch assembly also may include a seal member received in the elongated pocket. The seal member may define a seal axis and may be configured to provide an uninterrupted seal between the hatch lid and a hatch extension coupled to the compartment adjacent the opening. The seal member may include an inner seal portion and an outer seal portion at least partially coating the inner seal portion. The inner seal portion may be elastically compressible, and the outer seal portion may be chemically resistant. The seal member may define a cross-section perpendicular to the seal axis having an uncompressed dimension greater than the pocket width, such that the seal member is at least partially compressed as received in the elongated pocket.

In some embodiments, a seal member may be configured to provide an uninterrupted seal between a hatch lid and a hatch extension adjacent an opening providing access to an interior of a compartment, with the hatch lid being configured to be coupled to the hatch extension and to move between an open condition providing access via the opening to the interior of the compartment and a closed condition in which the opening is sealed. The seal member may define a seal axis and may include an inner seal portion and an outer seal portion at least partially coating the inner seal portion. The inner seal portion may be elastically compressible, and the outer seal portion may be chemically resistant. The seal member may define a cross-section perpendicular to the seal axis having an uncompressed dimension greater than a pocket width of an elongated pocket coupled to the hatch lid and into which the seal member is configured to be received, such that the seal member is at least partially compressed when received in the elongated pocket.

In some embodiments, a method for selectively sealing a compartment including an opening to an interior of the compartment, may include providing a sealable hatch assembly configured to move between an open condition providing access via the opening to the interior of the compartment on which the sealable hatch assembly is disposed and a closed condition in which the opening is sealed. The sealable hatch assembly may include an elongated pocket on the interior side of the hatch lid. The elongated pocket may at least partially define a pocket width. The sealable hatch assembly also may include a seal member received in the elongated pocket. The seal member may define a seal axis and may be configured to provide an uninterrupted seal between the hatch lid and a hatch extension coupled to the compartment adjacent the opening. The seal member may include an inner seal portion and an outer seal portion at least partially coating the inner seal portion. The inner seal portion may be elastically compressible, and the outer seal portion may be chemically resistant. The seal member may define a cross-section perpendicular to the seal axis having an uncompressed dimension greater than the pocket width, such that the seal member is at least partially compressed as received in the elongated pocket.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The detailed description is described with reference to the accompanying figures. The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings may be expanded or reduced to more clearly illustrate embodiments of the disclosure.

FIG. 1A is a perspective view of an example of a sealable hatch assembly shown in an example closed condition, according to embodiments of the disclosure.

FIG. 1B is a perspective partial section view of the example sealable hatch assembly shown in FIG. 1A, according to embodiments of the disclosure.

FIG. 1C is a perspective detailed section view of a portion of the example sealable hatch seal assembly shown in FIG. 1A and FIG. 1B, according to embodiments of the disclosure.

FIG. 2 is a perspective view of the example sealable hatch assembly shown in FIG. 1A in an example open condition, according to embodiments of the disclosure.

FIG. 3A is a perspective view of an example seal member separated from a sealable hatch assembly, according to embodiments of the disclosure.

FIG. 3B is a partial section view of a cross-section of the example seal member shown in FIG. 3A, according to embodiments of the disclosure.

FIG. 3C is a partial section view of a cross-section of another example seal member, according to embodiments of the disclosure.

FIG. 4A is a perspective view of another example of a sealable hatch assembly shown in an example closed condition, according to embodiments of the disclosure.

FIG. 4B is a perspective partial section view of the example sealable hatch assembly shown in FIG. 4A, according to embodiments of the disclosure.

FIG. 4C is a perspective detailed section view of a portion of the example sealable hatch assembly shown in FIG. 4A and FIG. 4B, according to embodiments of the disclosure.

FIG. 5 is a perspective view of the example sealable hatch assembly shown in FIG. 4A in an example open condition, according to embodiments of the disclosure.

FIG. 6A is a perspective view of an example seal member separated from a sealable hatch assembly, according to embodiments of the disclosure.

FIG. 6B is a partial section view of a cross-section of the example seal member shown in FIG. 6A, according to embodiments of the disclosure.

FIG. 6C is a partial section view of a cross-section of another example seal member, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

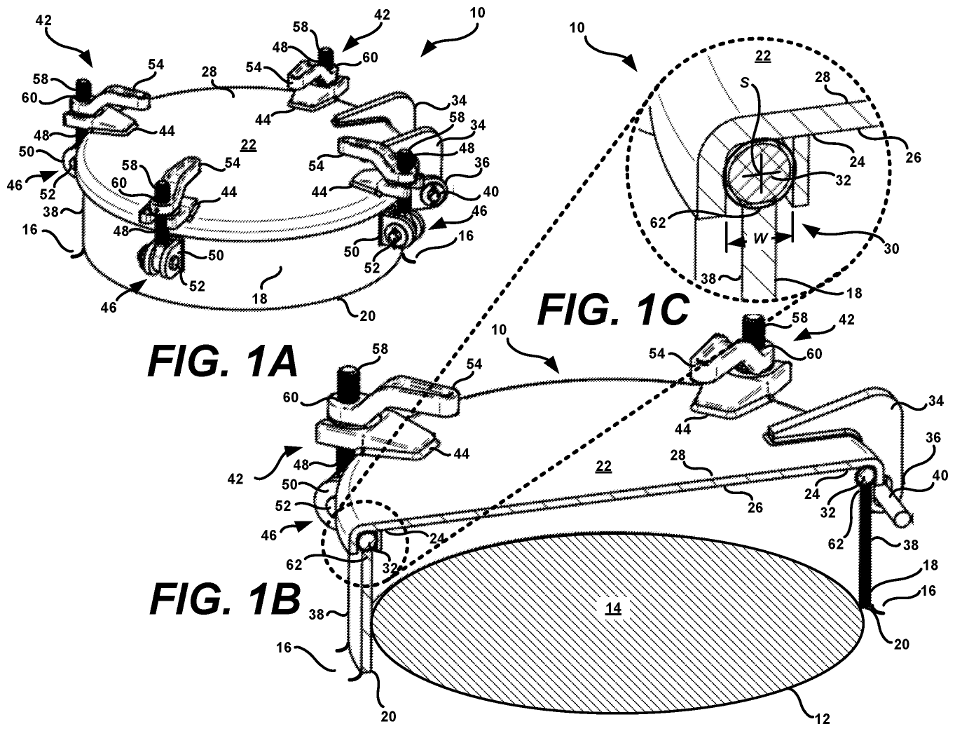

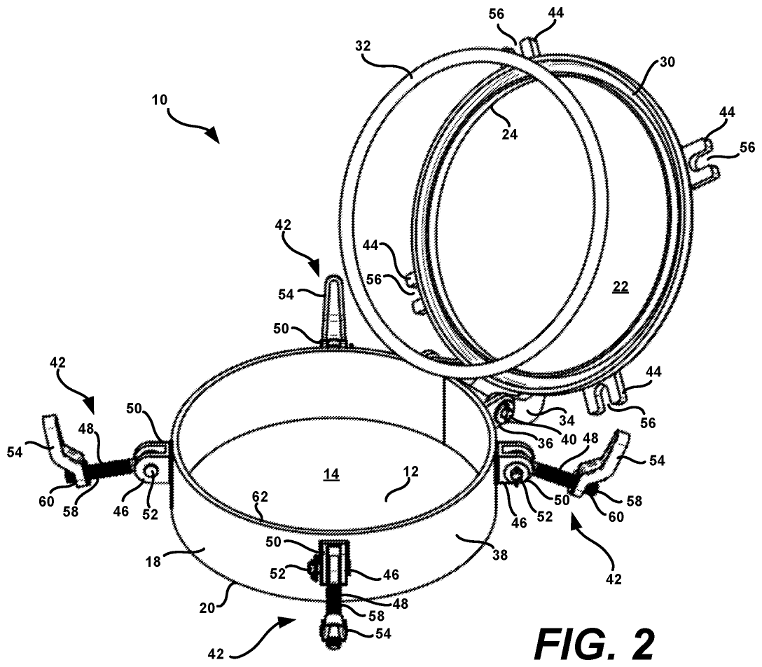

FIG. 1A is a perspective view of an example of a sealable hatch assembly 10 shown in an example closed condition, according to embodiments of the disclosure. The sealable hatch assembly 10 may be configured to move between an open condition (see, e.g., FIG. 2) providing access via an opening 12 to an interior 14 of a compartment 16 on which the sealable hatch assembly 10 is disposed, and a closed condition in which the access is sealed. For example, the compartment 16 may be stationary or may be part of a vehicle, such as a cargo vehicle, such as, for example, an aircraft, a truck, a tanker, a trailer, a ship, or a barge used to transport commodities, such as, for example, grain, minerals, and liquids such as water, petroleum-based fluids, and/or other types of fluids and liquids.

In some embodiments, the sealable hatch assembly 10 may be used to prevent potential contaminates, such as, for example, solids, liquids, and/or vapors, from entering the compartment through the opening 12 and/or material in the compartment 16, such as, for example, solids, liquids, and/or vapors, from escaping to the surrounding environment from the opening 12. As shown, the hatch assembly 10 may be provided to selectively open and close the opening 12 to facilitate transfer of materials into the compartment in the open condition and to seal the compartment from the surrounding environment in the closed condition.

As shown in FIG. 1B, a hatch extension 18 may be coupled to the compartment 16 adjacent the opening 12. The hatch extension 18 may be a portion of the compartment 16 and/or may be a portion of the sealable hatch assembly 10. For example, the sealable hatch assembly 10 may include the hatch extension 18, and the hatch extension 18 may be coupled to an exterior surface of the compartment 16 adjacent the opening 12, for example, such that the hatch extension 18 substantially or fully surrounds the opening 12. In some embodiments, a lower edge 20 of the hatch extension 18 may be coupled to the exterior surface of the compartment 16 via, for example, welding, adhesives, and/or fasteners, for example, such that the lower edge 20 of the hatch extension 18 is sealingly coupled to the outer surface of the compartment 16, for example, as shown in FIG. 1A and FIG. 1B.

In some embodiments, as shown in FIG. 1A, FIG. 1B, and FIG. 1C, the sealable hatch assembly 10 may include a hatch lid 22 providing a barrier defining a perimeter 24, an interior side 26 configured to face the interior 14 of the compartment 16 when in the closed condition, and an exterior side 28 opposite the interior side 26. As shown in FIG. 1B and FIG. 1C, in some embodiments, the sealable hatch assembly 10 may further include an elongated pocket 30 on the interior side 26 of the hatch lid 22 and extending adjacent the perimeter 24 on the interior side 26. As shown in FIG. 1C, the elongated pocket 30 may at least partially define a pocket width W perpendicular to an axis of the elongated pocket 30. In some embodiments, a seal member 32 may be received in the elongated pocket 30. The seal member 32, as shown in FIG. 1C, may define a seal axis S and may be configured to provide an uninterrupted seal between the hatch lid 22 and the hatch extension 18. In some embodiments, the seal member 32 may define a cross-section perpendicular to the seal axis S having an uncompressed dimension greater than the pocket width W, such that the seal member 32 is at least partially compressed when received in the elongated pocket 30. In some embodiments, the seal member 32 may be secured in the elongated pocket 30, such that the seal member 32 moves with the hatch lid 22 as the hatch lid 22 is moved between the closed condition (e.g., FIG. 1A) and the open condition (e.g., FIG. 2). Although FIG. 2 shows the seal member 32 separated from the hatch lid 22 for clarity, in some embodiments, the seal member 32 is secured to the hatch lid 22 in the elongated pocket 30. In some embodiments, the seal member 32 may be secured in the elongated pocket 30 via a press-fit, adhesive, and/or sealant. As shown, in some embodiments, the elongated pocket 30 and the seal member 32 are continuous and uninterrupted as they extend around the perimeter 24 of the interior side 26 of the hatch lid 22.

FIG. 2 is a perspective view of the example sealable hatch assembly 10 shown in FIG. 1A in an example open condition, according to embodiments of the disclosure. As shown in FIGS. 1A, 1B, 1C, and 2, in some embodiments, the sealable hatch assembly 10 also may include one or more hinge arms 34 coupled to the hatch lid 22, for example, via welding, adhesives, and/or fasteners. For example, as shown in FIGS. 1A and 1B, the hinge arms 34 may be secured to the exterior side 28 of the hatch lid 22. The sealable hatch assembly 10 further may include one or more hinge bosses 36 coupled to the hatch extension 18, for example, via welding, adhesives, and/or fasteners. For example, as shown in FIG. 1A and 2, the hinge bosses 36 may be secured to an exterior surface 38 of the hatch extension 18. The sealable hatch assembly 10 also may include one or more hinge pivots 40, each coupling a respective hinge arm 34 and a respective hinge boss 36 to one another, such that the hatch lid 22 is pivotable between the closed condition and the open condition (see, e.g., FIG. 2).

As shown in FIG. 1A and FIG. 2, in some embodiments, a clamp assembly 42 may be provided to secure the hatch lid 22 in the closed condition. For example, as shown, the clamp assembly 42 may include one or more clamp retainers 44 coupled to the hatch lid 22, for example, to the exterior side 28 of the hatch lid 22, via welding, adhesives, and/or fasteners. The clamp assembly 42 further may include one or more clamp bosses 46 coupled to the hatch extension 18, for example, via welding, adhesives, and/or fasteners. For example, as shown in FIG. 1A and 2, the clamp bosses 46 may be secured to the exterior surface 38 of the hatch extension 18. The clamp assembly 42 further may include one or more clamp pivots 48, each coupled to a respective clamp boss 46 and coupling a respective clamp retainer 44 and a respective clamp boss 46 to one another, for example, such that the clamp pivot 48 is pivotable relative to the clamp boss 46. For example, in some embodiments, the clamp boss 46 may include two spaced boss anchors 50, and a pivot pin 52 may extend between the spaced boss anchors 50 and through an aperture in the end of the clamp pivot 48 proximal the clamp boss 46, securing the clamp pivot 48 to the clamp boss 46, such that the clamp pivot 48 is able to pivot relative to the clamp boss 46 about the pivot pin 52. The pivot pin 52 may be secured to the clamp boss 48 via welding, adhesives, and/or fasteners.

As shown in FIG. 1A and FIG. 2, in some embodiments, the clamp assembly 42 further may include one or more clamp tighteners 54 engaged with an end of a respective clamp pivot 48 remote from a respective clamp boss 46. In some embodiments, the one or more clamp tighteners 54 may be configured to (i) facilitate increasing the clamping force between the seal member 32 and the hatch extension 18 when the hatch lid 22 is in the closed condition (see, e.g., FIGS. 1A through 1C); and (ii) facilitate separation of a respective clamp retainer 44 from a respective clamp pivot 48 when the hatch lid 22 is moved from the closed condition to the open condition (see, e.g., FIG. 2).

As shown in FIG. 2, in some embodiments, the clamp retainers 44 may each at least partially define an open-ended retainer slot 56 configured to receive an end of a respective clamp pivot 48 remote from the respective clamp boss 46. For example, in some embodiments, the end of the clamp pivot 48 remote from the clamp boss 46 may include a threaded portion 58, and the respective clamp tightener 54 may at least partially define a threaded aperture 60 configured to receive therein the threaded portion 58 of the clamp pivot 48.

As shown in FIG. 1C, in some embodiments, when the hatch lid 22 is in the closed condition, the hatch extension 18 presses against the seal member 32, thereby providing a seal between the hatch extension 18 and the seal member 32. The respective clamp tighteners 54 may be tightened on the respective clamp pivots 48 by rotating the clamp tighteners 54 on the threaded portions 58 of the respective clamp pivots 48, such that the clamp tighteners 54 apply a clamping force against the clamp retainers 44, resulting in squeezing the hatch lid 22 against the hatch extension 18, such that an upper edge 62 of the hatch extension 18 is pressed against the seal member 32, for example, as shown in FIG. 1C. As shown in FIG. 1C, in some embodiments, the thickness of the upper edge 62 of the hatch extension 18 is less than the width W of the elongated pocket 30.

To move the hatch lid 22 from the closed condition shown in FIGS. 1A through 1C to the open condition shown FIG. 2, according to some embodiments, the clamp tighteners 54 may be loosened relative to the respective clamp retainers 44 by rotation in the opposite direction (e.g., by un-screwing them) relative to the respective clamp pivots 48, thereby releasing the pressure between the upper edge 62 of the hatch extension 18 and the seal member 32. As shown in FIG. 2, for example, as the clamp tighteners 54 begin to separate from the respective clamp retainers 44, the clamp tighteners 54 and the respective clamp pivots 48 may pivot outward relative to the respective clamp retainers 44 on the hatch lid 22, for example, via the respective open-ended retainer slots 56 of the clamp retainers 44. Once the clamp tighteners 54 and the respective clamp pivots 48 have been separated from the respective clamp retainers 44 and pivoted outward as shown in FIG. 2, the hatch lid 22 may be pivoted relative to the hatch extension 18, for example, with the one or more hinge arms 34 pivoting relative to the hinge bosses 36 about the one or more hinge pivots 40, resulting in the hatch lid 18 moving from the closed condition (see, e.g., FIGS. 1A through 1C) to the open condition (see, e.g., FIG. 2), thereby providing access to the opening 12 of the compartment 16.

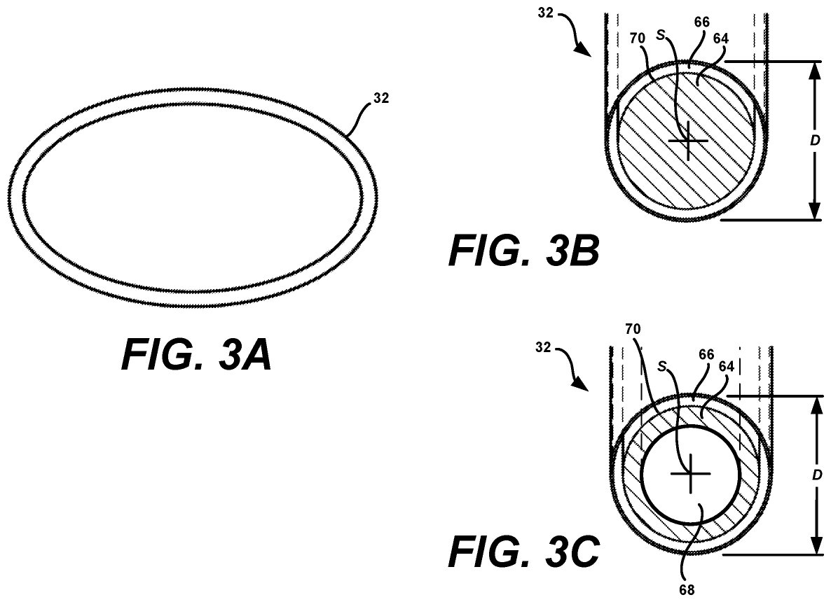

FIG. 3A is a perspective view of an example seal member 32 separated from a sealable hatch assembly 10, according to embodiments of the disclosure, and FIG. 3B is a partial section view of a cross-section of the example seal member shown in FIG. 3A, according to embodiments of the disclosure. As shown in FIG. 3A, the seal member 32, in some embodiments, may be substantially continuous, for example, forming a closed ring. In some embodiments, the seal member 32 may be formed by extrusion, and end points of segments of the seal member 32 may be joined to form the ring. In some embodiments, the seal member 32 may be formed by injection molding. Other manufacturing methods for forming the seal member 32 are contemplated.

As shown in FIG. 3B, in some embodiments, the seal member 32 may include an inner seal portion 64 and an outer seal portion 66 at least partially coating the inner seal portion 64. In some embodiments, the inner seal portion 64 may be elastically compressible, and the outer seal portion 66 may be chemically resistant. As shown, the inner seal portion 64 and the outer seal portion 66 may define a cross-section perpendicular to the seal axis S having an uncompressed dimension D (e.g., a diameter when the cross-section is circular) greater than the pocket width W, such that the seal member 32 is at least partially compressed when received in the elongated pocket 30 associated with the hatch lid 22. In some embodiments, the uncompressed dimension D may range, for example, from about 0.50 inches to about 1.00 inches, from about 0.60 inches to about 1.00 inches, from about 0.70 inches to about 1.00 inches, from about 0.80 inches to about 1.00 inches, from about 0.50 inches to about 0.90 inches, from about 0.50 inches to about 0.80 inches, from about 0.50 inches to about 0.75 inches, from about 0.50 inches to about 0.70 inches, from about 0.60 inches to about 0.90 inches, from about 0.70 inches to about 0.80 inches (e.g., about 0.75 inches), or from about 0.65 inches to about 0.85 inches, although other uncompressed dimensions are contemplated.

In some embodiments, the elongated pocket 30, the seal member 32, and/or the hatch extension 18 are configured, such that when the hatch lid 22 is in the closed condition, the hatch extension 18 at least partially compresses the seal member 32 in the elongated pocket 30. For example, in some embodiments, the elongated pocket 30, the seal member 32, and/or the hatch extension 18 may be configured, such that when the hatch lid 22 is in the closed condition, the hatch lid 22 is configured to seal the opening 12 at a pressure differential ranging, for example, from about minus 10 pounds-per-square-inch (psi) to about 10 psi, from about minus 7 psi to about 7 psi, from about minus 5 psi to about 5 psi, from about minus 4 psi to about 4 psi, from about minus 3 psi to about 3 psi, from about minus 2 psi to about 2 psi, or from about minus 1 psi to about 1 psi, where the pressure differential is indicative of a difference between an interior pressure in the compartment 16 and an exterior or ambient pressure on the exterior side 28 of the hatch lid 22.

In some embodiments, the inner seal portion 64 of the seal member 32 may include one or more of, for example, silicones, polysiloxanes, fluoroelastomers, such as, for example, FKMs such as Type-1 FKM, Type-2 FKM, Type-3 FKM, Type-4 FKM, and Type-5 FKM, and VITON™, and/or any other similar materials having similar characteristics. In some embodiments, the inner seal portion 64 of the seal member 32 may have a hardness ranging, for example, from about Shore 15A to about Shore 100A, from about Shore 20A to about Shore 90A, from about Shore 25A to about Shore 80A, from about Shore 30A to about Shore 75A, from about Shore 35A to about Shore 70A, from about Shore 40A to about Shore 70A, from about Shore 45A to about Shore 65A, from about Shore 40A to about Shore 65A, from about Shore 40A to about Shore 60A, or from about from about Shore 50A to about Shore 60A, although other hardnesses are contemplated.

As shown in FIG. 3B, in some embodiments, the inner seal portion 64 of the seal member 32 may be solid, for example, such that the inner seal portion 64 is substantially devoid of cavities lacking the material or materials of the inner seal portion 64. As shown in FIG. 3C, which is a partial section view of an example cross-section of another example seal member 32, according to embodiments of the disclosure, in some embodiments, the inner seal portion 64 of the seal member 32 may define at least one interior chamber 68, for example, that is either substantially devoid of material (e.g., and contains air and/or another gas or gasses), or that includes a different material (or one or more different materials) than the material or materials of an outer surface 70 of the inner seal portion 64. In some such embodiments, such a construction may be used to tailor the compressibility and/or elasticity of the seal member 32, for example, to adjust the pressure differential the seal member 32 is able to withstand. In some embodiments, the one or more interior chambers 68 may extend the length of the seal member 32, for example, the entire extent of the ring of the seal member 32 when formed into a ring. In some embodiments, the one or more interior chambers 68 may be discontinuous with respect to the length of the seal member 32. Some such embodiments may provide different levels of compressibility and/or elasticity at different points along the length or extent of the seal member 32.

In some embodiments, the outer seal portion 66 may include one or more of, for example, fluorinated ethylene propylene (FEP), polytetrafluoroethylene (PTFE), high-fluorine perfluoroelastomeric compounds such as FFKMs, FKM fluoroelastomers, and/or any other similar materials having similar characteristics. In some embodiments, the outer seal portion 66 of the seal member 32 may be chemically-resistant with respect to one or more of, for example, acetic acids, ketones such as acetone, hydrochloric acids, petroleum distillates, naphtha, crude oil, kerosene, gasoline, petroleum-based compounds, and/or any other similar materials having similar characteristics. In some embodiments, the outer seal portion 66 of the seal member 32 may have a hardness ranging, for example, from about Shore 15D to about Shore 100D, from about Shore 20D to about Shore 90D, from about Shore 20D to about Shore 80D (e.g., from about Shore 30D to about Shore 60D), from about Shore 30D to about Shore 75D, from about Shore 35D to about Shore 70D, from about Shore 40D to about Shore 70D, from about Shore 45D to about Shore 65D, from about Shore 40D to about Shore 65D, from about Shore 40D to about Shore 60D, or from about from about Shore 50D to about Shore 60D, although other hardnesses are contemplated.

The outer seal portion 66 of the seal member 32 may have a maximum thickness ranging, for example, from about 0.002 inches to about 0.50 inches, from about 0.003 inches to about 0.45 inches, from about 0.004 inches to about 0.40 inches, from about 0.005 inches to about 0.350 inches, from about 0.005 inches to about 0.30 inches, from about 0.005 inches to about 0.250 inches, from about 0.005 inches to about 0.20 inches, from about 0.006 inches to about 0.250 inches, or from about 0.004 inches to about 0.250 inches, although other thicknesses are contemplated. In some embodiments, the maximum thickness of the outer seal portion 66 may range, for example, from about 0.2 percent to about 100 percent of the uncompressed dimension D of the cross-section of the seal member 32, from about 0.2 percent to about 100 percent, from about 0.5 percent to about 50 percent, from about 0.6 percent (e.g., 0.66 percent) to about 50 percent (e.g., about 30 percent), from about one percent to about 50 percent, from about 25 percent to about 50 percent, from about 30 percent to about 40 percent, from about 35 percent to about 50 percent, or from about 15 percent to about 50 percent of the uncompressed dimension D of the cross-section of the seal member 32. In some embodiments, for example, as shown in FIGS. 3B and 3C, the outer seal portion 66 may coat or encapsulate the entire outer surface 70 of the inner seal portion 64 of the seal member 32. In some embodiments, however, the outer seal portion 66 may coat less than the entire outer surface 70 of the inner seal portion 64. For example, the outer seal portion 66 may coat at least 50% of the outer surface 70 of the inner seal portion 64, at least 60% of the outer surface 70 of the inner seal portion 64, at least 70% of the outer surface 70 of the inner seal portion 64, at least 80% of the outer surface 70 of the inner seal portion 64, or at least 90% of the outer surface 70 of the inner seal portion 64. In some embodiments, the partial coating may extend longitudinally along the length or extent of the seal member 32, and in some embodiments, the partial coating may extend partially or fully around the seal member 32 at discrete segments along the length or extent of the seal member 32, for example, in a manner similar to rings around the outer surface 70 of the inner portion 64 of the seal member 32.

In some embodiments, the inner seal portion 64 and the outer seal portion 66 may be formed by extrusion, for example, by co-extruding the inner seal portion 64 and the outer seal portion 66. In some embodiments, the outer seal portion 66 may be applied to the inner seal portion 64 after the inner seal portion 64 has been formed, for example, via spraying, deposition, brushing, dipping, and/or coating methods. In some embodiments, the inner seal portion 64 and/or the outer seal portion 66 may be formed by injection molding, either separately or together. Other manufacturing methods for forming the seal member 32 are contemplated.

Although the example embodiments of the seal member 32 shown in FIGS. 3B and 3C have circular cross-sections, other cross-sectional shapes are contemplated. For example, the cross-section of the seal member 32 may be oval-shaped, polygonal, rectangular, square, octagonal, hexagonal, and/or other shape or combination of shapes. In some embodiments, the elongated pocket 30 may at least partially define a pocket cross-section perpendicular to a longitudinal pocket axis, and the pocket cross-section may be semi-circular, oval-shaped, rectangular, square, octagonal, hexagonal, and/or any other shape or combination of shapes.

The embodiments of seal hatch assembly 10 shown in FIG. 1A through FIG. 2 are substantially circular, for example, such that the hatch lid 22 is circular as viewed from the interior side 26 or the exterior side 28 of the hatch lid 22. In some such embodiments, the hatch extension 18 and the elongated pocket 30 also may be circular. In some embodiments, the hatch lid 22, the elongated pocket 30, and/or the hatch extension 18 may be substantially-oval shaped, polygonal, square, rectangular, octagonal, hexagonal, and/or any other shape or combination of shapes.

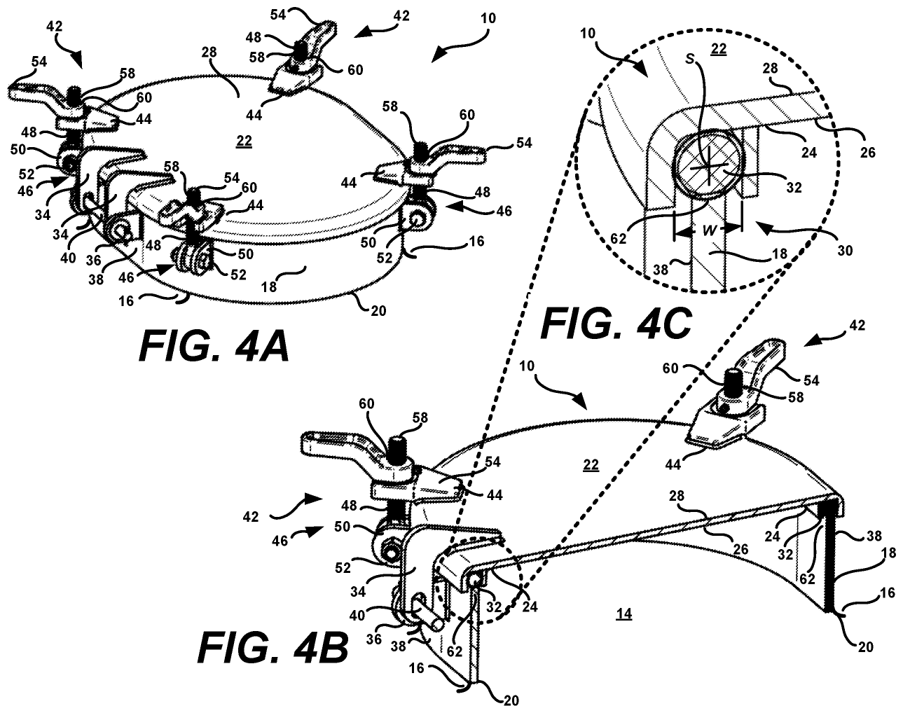

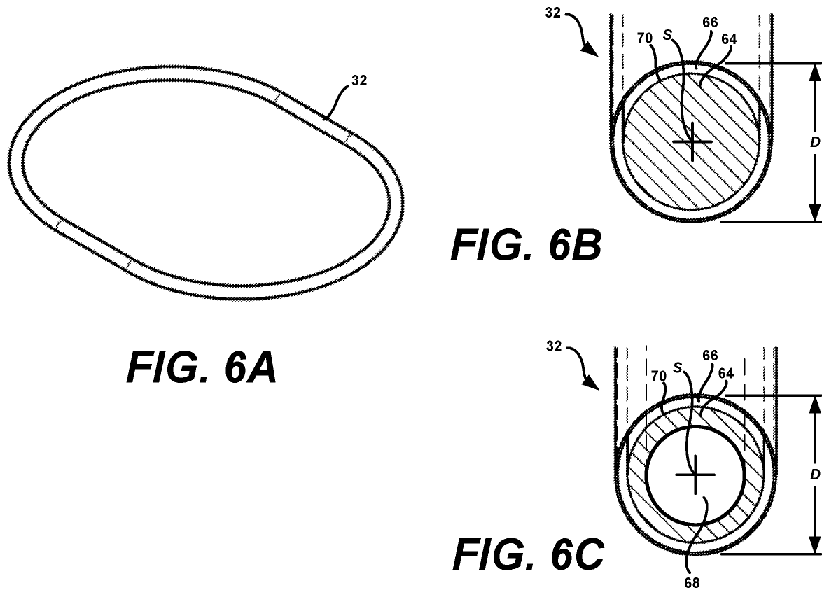

For example, FIG. 4A is a perspective view of another example of a sealable hatch assembly 10 shown in an example closed condition, according to embodiments of the disclosure. FIG. 4B is a perspective partial section view of the example sealable hatch assembly 10 shown in FIG. 4A, according to embodiments of the disclosure, and FIG. 4C is a perspective detailed section view of a portion of the example sealable hatch assembly 10 shown in FIG. 4A and FIG. 4B, according to embodiments of the disclosure. FIG. 4A, FIG. 4B, and FIG. 4C show example embodiments of a sealable hatch assembly 10 that includes a substantially oval-shaped hatch lid 22, a substantially oval-shaped elongated pocket 30, and a substantially oval-shaped hatch extension 18. In some embodiments, the seal member 32 may have a shape and/or size that substantially corresponds to the shape and/or size of the elongated pocket 30, the hatch extension 18, and/or the hatch lid 22. For example, FIG. 6A shows another example seal member 32 that is substantially oval-shaped. In some embodiments, the shape and/or size of one or more of the hatch lid 22, the elongated pocket 30, the hatch extension 18, and/or the seal member 32 may differ from one another. For example, the shape (or shapes) and/or the size (or sizes) of the elongated pocket 30, the hatch extension 18, and/or the seal member 32 may differ from the shape and/or size of the hatch lid 22.

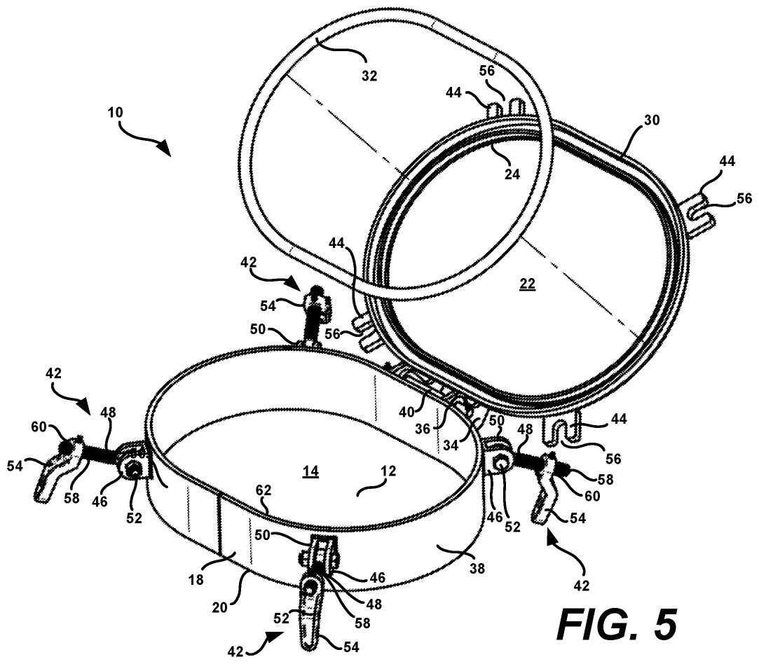

The example embodiments shown in FIG. 4A, FIG. 4B, FIG. 4C, and FIG. 5, except as noted otherwise herein, may be at least substantially similar to the example embodiments shown in FIG. 1A, FIG. 1B, FIG. 1C, and FIG. 2, respectively. FIG. 5 is a perspective view of the example sealable hatch assembly 10 shown in FIG. 4A in an example open condition, and FIG. 6A and FIG. 6B are a perspective view and a partial section view, respectively, of an example cross-section of an example seal member 32 separated from the sealable hatch assembly 10 shown in FIG. 4A through FIG. 5, according to embodiments of the disclosure. The example seal member 32 embodiments shown in FIG. 6A, FIG. 6B, and FIG. 6C, except as noted otherwise herein, may be at least substantially similar to the example seal member 32 embodiments shown in FIG. 3A, FIG. 3B, and FIG. 3C, respectively.

FIG. 4A is a perspective view of another example of a sealable hatch assembly 10 shown in an example closed condition, according to embodiments of the disclosure. The sealable hatch assembly 10 may be configured to move between an open condition (see, e.g., FIG. 2) providing access via an opening 12 to an interior 14 of a compartment 16 on which the sealable hatch assembly 10 is disposed, and a closed condition in which the access is sealed. For example, the compartment 16 may be stationary or may be part of a vehicle, such as a cargo vehicle, such as, for example, an aircraft, a truck, a tanker, a trailer, a ship, or a barge used to transport commodities, such as, for example, grain, minerals, and liquids, such as water, petroleum-based fluids, and/or other types of fluids and liquids.

In some embodiments, the sealable hatch assembly 10 may be used to prevent potential contaminates, such as, for example, solids, liquids, and/or vapors, from entering the compartment through the opening 12 and/or material in the compartment 16, such as, for example, solids, liquids, and/or vapors, from escaping to the surrounding environment from the opening 12. As shown, the hatch assembly 10 may be provided to selectively open and close the opening 12 to facilitate transfer of materials into the compartment in the open condition and to seal the compartment from the surrounding environment in the closed condition.

As shown in FIG. 4B, a hatch extension 18 may be coupled to the compartment 16 adjacent the opening 12. The hatch extension 18 may be a portion of the compartment 16 and/or may be a portion of the sealable hatch assembly 10. For example, the sealable hatch assembly 10 may include the hatch extension 18, and the hatch extension 18 may be coupled to an exterior surface of the compartment 16 adjacent the opening 12, for example, such that the hatch extension 18 substantially or fully surrounds the opening 12. In some embodiments, a lower edge 20 of the hatch extension 18 may be coupled to the exterior surface of the compartment 16 via, for example, welding, adhesives, and/or fasteners, for example, such that the lower edge 20 of the hatch extension 18 is sealingly coupled to the outer surface of the compartment 16, for example, as shown in FIG. 4A and FIG. 4B.

In some embodiments, as shown in FIG. 4A, FIG. 4B, and FIG. 4C, the sealable hatch assembly 10 may include a hatch lid 22 providing a barrier defining a perimeter 24, an interior side 26 configured to face then interior 14 of the compartment 16 when in the closed condition, and an exterior side 28 opposite the interior side 26. As shown in FIG. 4B and FIG. 4C, in some embodiments, the sealable hatch assembly 10 may further include an elongated pocket 30 on the interior side 26 of the hatch lid 22 and extending adjacent the perimeter 24 on the interior side 26. As shown in FIG. 4C, the elongated pocket 30 may at least partially define a pocket width W perpendicular to an axis of the elongated pocket 30. In some embodiments, a seal member 32 may be received in the elongated pocket 30. The seal member 32, as shown in FIG. 4C, may define a seal axis S and may be configured to provide an uninterrupted seal between the hatch lid 22 and the hatch extension 18. In some embodiments, the seal member 32 may define a cross-section perpendicular to the seal axis S having an uncompressed dimension greater than the pocket width W, such that the seal member 32 is at least partially compressed when received in the elongated pocket 30. In some embodiments, the seal member 32 may be secured in the elongated pocket 30, such that the seal member 32 moves with the hatch lid 22 as the hatch lid 22 is moved between the closed condition (e.g., FIG. 4A) and the open condition (e.g., FIG. 5). Although FIG. 5 shows the seal member 32 separated from the hatch lid 22 for clarity, in some embodiments, the seal member 32 is secured to the hatch lid 22 in the elongated pocket 30. As shown, in some embodiments, the elongated pocket 30 and the seal member 32 are continuous and uninterrupted as they extend around the perimeter 24 of the interior side 26 of the hatch lid 22.

FIG. 2 is a perspective view of the example sealable hatch assembly 10 shown in FIG. 4A in an example open condition, according to embodiments of the disclosure. As shown in FIGS. 4A, 4B, 4C, and 5, in some embodiments, the sealable hatch assembly 10 also may include one or more hinge arms 34 coupled to the hatch lid 22, for example, via welding, adhesives, and/or fasteners. For example, as shown in FIGS. 4A and 4B, the hinge arms 34 may be secured to the exterior side 28 of the hatch lid 22. The sealable hatch assembly 10 further may include one or more hinge bosses 36 coupled to the hatch extension 18, for example, via welding, adhesives, and/or fasteners. For example, as shown in FIG. 4A and 5, the hinge bosses 36 may be secured to an exterior surface 38 of the hatch extension 18. The sealable hatch assembly 10 also may include one or more hinge pivots 40, each coupling a respective hinge arm 34 and a respective hinge boss 36 to one another, such that the hatch lid 22 is pivotable between the closed condition and the open condition (see, e.g., FIG. 5).

As shown in FIG. 4A and FIG. 5, in some embodiments, a clamp assembly 42 may be provided to secure the hatch lid 22 in the closed condition. For example, as shown, the clamp assembly 42 may include one or more clamp retainers 44 coupled to the hatch lid 22, for example, to the exterior side 28 of the hatch lid 22, via welding, adhesives, and/or fasteners. The clamp assembly 42 further may include one or more clamp bosses 46 coupled to the hatch extension 18, for example, via welding, adhesives, and/or fasteners. For example, as shown in FIG. 4A and 5, the clamp bosses 46 may be secured to the exterior surface 38 of the hatch extension 18. The clamp assembly 42 further may include one or more clamp pivots 48, each coupled to a respective clamp boss 46 and coupling a respective clamp retainer 44 and a respective clamp boss 46 to one another, for example, such that the clamp pivot 48 is pivotable relative to the clamp boss 46. For example, in some embodiments, the clamp boss 46 may include two spaced boss anchors 50, and a pivot pin 52 may extend between the spaced boss anchors 50 and through an aperture in the end of the clamp pivot 48 proximal the clamp boss 46, securing the clamp pivot 48 to the clamp boss 46, such that the clamp pivot 48 is able to pivot relative to the clamp boss 46 about the pivot pin 52. The pivot pin 52 may be secured to the clamp boss 48 via welding, adhesives, and/or fasteners.

As shown in FIG. 4A and FIG. 5, in some embodiments, the clamp assembly 42 further may include one or more clamp tighteners 54 engaged with an end of a respective clamp pivot 48 remote from a respective clamp boss 46. In some embodiments, the one or more clamp tighteners 54 may be configured to (i) facilitate increasing the clamping force between the seal member 32 and the hatch extension 18 when the hatch lid 22 is in the closed condition (see, e.g., FIG. 4A through FIG. 4C); and (ii) facilitate separation of a respective clamp retainer 44 from a respective clamp pivot 48 when the hatch lid 22 is moved from the closed condition to the open condition (see, e.g., FIG. 5).

As shown in FIG. 5, in some embodiments, the clamp retainers 44 may each at least partially define an open-ended retainer slot 56 configured to receive an end of a respective clamp pivot 48 remote from the respective clamp boss 46. For example, in some embodiments, the end of the clamp pivot 48 remote from the clamp boss 46 may include a threaded portion 58, and the respective clamp tightener 54 may at least partially define a threaded aperture 60 configured to receive therein the threaded portion 58 of the clamp pivot 48.

As shown in FIG. 4C, in some embodiments, when the hatch lid 22 is in the closed condition, the hatch extension 18 presses against the seal member 32, thereby providing a seal between the hatch extension 18 and the seal member 32. The respective clamp tighteners 54 may be tightened on the respective clamp pivots 48 by rotating the clamp tighteners 54 on the threaded portions 58 of the respective clamp pivots 48, such that the clamp tighteners 54 apply a clamping force against the clamp retainers 44, resulting in squeezing the hatch lid 22 against the hatch extension 18, such that an upper edge 62 of the hatch extension 18 is pressed against the seal member 32, for example, as shown in FIG. 4C. As shown in FIG. 4C, in some embodiments, the thickness of the upper edge 62 of the hatch extension 18 is less than the width W of the elongated pocket 30.

To move the hatch lid 22 from the closed condition shown in FIGS. 1A through 1C to the open condition shown FIG. 5, according to some embodiments, the clamp tighteners 54 may be loosened relative to the respective clamp retainers 44 by rotation in the opposite direction (e.g., by un-screwing them) relative to the respective clamp pivots 48, thereby releasing the pressure between the upper edge 62 of the hatch extension 18 and the seal member 32. As shown in FIG. 5, for example, as the clamp tighteners 54 begin to separate from the respective clamp retainers 44, the clamp tighteners 54 and the respective clamp pivots 48 may pivot outward relative to the respective clamp retainers 44 on the hatch lid 22, for example, via the respective open-ended retainer slots 56 of the clamp retainers 44. Once the clamp tighteners 54 and the respective clamp pivots 48 have been separated from the respective clamp retainers 44 and rotated outward as shown in FIG. 5, the hatch lid 22 may be pivoted relative to the hatch extension 18, for example, with the one or more hinge arms 34 pivoting relative to the hinge bosses 36 about the one or more hinge pivots 40, resulting in the hatch lid 18 moving from the closed condition (see, e.g., FIG. 4A through FIG. 4C) to the open condition (see, e.g., FIG. 5), thereby providing access to the opening 12 of the compartment 16.

FIG. 6A is a perspective view of an example seal member 32 separated from a sealable hatch assembly 10, according to embodiments of the disclosure, and FIG. 6B is a partial section view of a cross-section of the example seal member shown in FIG. 6A, according to embodiments of the disclosure. As shown in FIG. 6A, the seal member 32, in some embodiments, may be substantially continuous, for example, forming a closed ring. In some embodiments, the seal member 32 may be formed by extrusion, and end points of segments of the seal member 32 may be joined to form the ring. In some embodiments, the seal member 32 may be formed by injection molding. Other manufacturing methods for forming the seal member 32 are contemplated.

As shown in FIG. 6B, in some embodiments, the seal member 32 may include an inner seal portion 64 and an outer seal portion 66 at least partially coating the inner seal portion 64. In some embodiments, the inner seal portion 64 may be elastically compressible, and the outer seal portion 66 may be chemically resistant. As shown, the inner seal portion 64 and the outer seal portion 66 may define a cross-section perpendicular to the seal axis S having an uncompressed dimension D (e.g., a diameter when the cross-section is circular) greater than the pocket width W, such that the seal member 32 is at least partially compressed when received in the elongated pocket 30 associated with the hatch lid 22.

In some embodiments, the elongated pocket 30, the seal member 32, and/or the hatch extension 18 are configured, such that when the hatch lid 22 is in the closed condition, the hatch extension 18 at least partially compresses the seal member 32 in the elongated pocket 30. For example, in some embodiments, the elongated pocket 30, the seal member 32, and/or the hatch extension 18 may be configured, such that when the hatch lid 22 is in the closed condition, the hatch lid 22 is configured to seal the opening 12 at a pressure differential ranging, for example, from about minus 10 pounds-per-square-inch (psi) to about 10 psi, from about minus 7 psi to about 7 psi, from about minus 5 psi to about 5 psi, from about minus 4 psi to about 4 psi, from about minus 3 psi to about 3 psi, from about minus 2 psi to about 2 psi, or from about minus 1 psi to about 1 psi, where the pressure differential is indicative of a difference between an interior pressure in the compartment 16 and an exterior pressure on the exterior side 28 of the hatch lid 22.

In some embodiments, the inner seal portion 64 of the seal member 32 may include one or more of, for example, silicones, polysiloxanes, fluoroelastomers, such as, for example, FKMs such as Type-1 FKM, Type-2 FKM, Type-3 FKM, Type-4 FKM, and Type-5 FKM, and VITON™, and/or any other similar materials having similar characteristics. In some embodiments, the inner seal portion 64 of the seal member 32 may have a hardness ranging, for example, from about Shore 15A to about Shore 100A, from about Shore 20A to about Shore 90A, from about Shore 25A to about Shore 80A, from about Shore 30A to about Shore 75A, from about Shore 35A to about Shore 70A, from about Shore 40A to about Shore 70A, from about Shore 45A to about Shore 65A, from about Shore 40A to about Shore 65A, from about Shore 40A to about Shore 60A, or from about from about Shore 50A to about Shore 60A, although other hardnesses are contemplated.

As shown in FIG. 6B, in some embodiments, the inner seal portion 64 of the seal member 32 may be solid, for example, such that the inner seal portion 64 is substantially devoid of cavities lacking the material or materials of the inner seal portion 64. As shown in FIG. 6C, which is a partial section view of an example cross-section of another example seal member 32, according to embodiments of the disclosure, in some embodiments, the inner seal portion 64 of the seal member 32 may define at least one interior chamber 68, for example, that is either substantially devoid of material (e.g., and contains air and/or another gas or gasses), or that includes a different material (or one or more different materials) than the material or materials of an outer surface 70 of the inner seal portion 64. In some such embodiments, such a construction may be used to tailor the compressibility and/or elasticity of the seal member 32, for example, to adjust the pressure differential the seal member 32 is able to withstand. In some embodiments, the one or more interior chambers 68 may extend the length of the seal member 32, for example, the entire extent of the ring of the seal member 32 when formed into a ring. In some embodiments, the one or more interior chambers 68 may be discontinuous with respect to the length of the seal member 32. Some such embodiments may provide different levels of compressibility and/or elasticity at different points along the length or extent of the seal member 32.

In some embodiments, the outer seal portion 66 may include one or more of, for example, fluorinated ethylene propylene (FEP), polytetrafluoroethylene (PTFE), high-fluorine perfluoroelastomeric compounds such as FFKMs, FKM fluoroelastomers, and/or any other similar materials having similar characteristics. In some embodiments, the outer seal portion 66 of the seal member 32 may be chemically-resistant with respect to one or more of, for example, acetic acids, ketones such as acetone, hydrochloric acids, petroleum distillates, naphtha, crude oil, kerosene, gasoline, petroleum-based compounds, and/or any other similar materials having similar characteristics. In some embodiments, the outer seal portion 66 of the seal member 32 may have a hardness ranging, for example, from about Shore 15D to about Shore 100D, from about Shore 20D to about Shore 90D, from about Shore 20D to about Shore 80D (e.g., from about Shore 30D to about Shore 60D), from about Shore 30D to about Shore 75D, from about Shore 35D to about Shore 70D, from about Shore 40D to about Shore 70D, from about Shore 45D to about Shore 65D, from about Shore 40D to about Shore 65D, from about Shore 40D to about Shore 60D, or from about from about Shore 50D to about Shore 60D, although other hardnesses are contemplated.

The outer seal portion 66 of the seal member 32 may have a maximum thickness ranging from about, for example, from about 0.002 inches to about 0.50 inches, from about 0.003 inches to about 0.45 inches, from about 0.004 inches to about 0.40 inches, from about 0.005 inches to about 0.350 inches, from about 0.005 inches to about 0.30 inches, from about 0.005 inches to about 0.250 inches, from about 0.005 inches to about 0.20 inches, from about 0.006 inches to about 0.250 inches, or from about 0.004 inches to about 0.250 inches, although other thicknesses are contemplated. In some embodiments, the maximum thickness of the outer seal portion 66 may range, for example, from about 0.2 percent to about 100 percent of the uncompressed dimension D of the cross-section of the seal member 32, from about 0.2 percent to about 100 percent, from about 0.5 percent to about 50 percent, from about 0.6 percent (e.g., 0.66 percent) to about 50 percent (e.g., about 30 percent), from about one percent to about 50 percent, from about 25 percent to about 50 percent, from about 30 percent to about 40 percent, from about 35 percent to about 50 percent, or from about 15 percent to about 50 percent of the uncompressed dimension D of the cross-section of the seal member 32. In some embodiments, for example, as shown in FIG. 6B and FIG. 6C, the outer seal portion 66 may coat or encapsulate the entire outer surface 70 of the inner seal portion 64 of the seal member 32. In some embodiments, however, the outer seal portion 66 may coat less than the entire outer surface 70 of the inner seal portion 64. For example, the outer seal portion 66 may coat at least 50% of the outer surface 70 of the inner seal portion 64, at least 60% of the outer surface 70 of the inner seal portion 64, at least 70% of the outer surface 70 of the inner seal portion 64, at least 80% of the outer surface 70 of the inner seal portion 64, or at least 90% of the outer surface 70 of the inner seal portion 64. In some embodiments, the partial coating may extend longitudinally along the length or extent of the seal member 32, and in some embodiments, the partial coating may extend partially or fully around the seal member 32 at discrete segments along the length or extent of the seal member 32, for example, in a manner similar to rings around the outer surface 70 of the inner portion 64 of the seal member 32.

In some embodiments, the inner seal portion 64 and the outer seal portion 66 may be formed by extrusion, for example, by co-extruding the inner seal portion 64 and the outer seal portion 66. In some embodiments, the outer seal portion 66 may be applied to the inner seal portion 64 after the inner seal portion 64 has been formed, for example, via spraying, deposition, brushing, dipping, and/or coating methods. In some embodiments, the inner seal portion 64 and/or the outer seal portion 66 may be formed by injection molding, either separately or together. Other manufacturing methods for forming the seal member 32 are contemplated.

Although the example embodiments of the seal member 32 shown in FIG. 6B and FIG. 6C have circular cross-sections, other cross-sectional shapes are contemplated. For example, the cross-section of the seal member 32 may be oval-shaped, polygonal, rectangular, square, octagonal, hexagonal, and/or any other shape or combination of shapes. In some embodiments, the elongated pocket 30 may at least partially define a pocket cross-section perpendicular to a longitudinal pocket axis, and the pocket cross-section may be semi-circular, oval-shaped, rectangular, square, octagonal, hexagonal, and/or any other shape or combination of shapes.

A method for selectively sealing a compartment including an opening to an interior of the compartment, may include providing a sealable hatch assembly configured to move between an open condition providing access via the opening to the interior of the compartment on which the sealable hatch assembly is disposed and a closed condition in which the opening is sealed. The sealable hatch assembly may include an elongated pocket on the interior side of the hatch lid and extending adjacent the perimeter on the interior side. The elongated pocket may at least partially define a pocket width. The sealable hatch assembly also may include a seal member received in the elongated pocket. The seal member may define a seal axis and may be configured to provide an uninterrupted seal between the hatch lid and a hatch extension coupled to the compartment adjacent the opening. The seal member may include an inner seal portion and an outer seal portion at least partially coating the inner seal portion. The inner seal portion may be elastically compressible, and the outer seal portion may be chemically resistant. The inner seal portion and the outer seal portion may define a cross-section perpendicular to the seal axis having an uncompressed dimension greater than the pocket width, such that the seal member is at least partially compressed as received in the elongated pocket. The method may further include providing any one of the aspects of the sealable hatch assembly 10 described herein and/or shown in FIG. 1A, FIG. 1B, FIG. 1C, FIG. 2, FIG. 3A, FIG. 3B, FIG. 3C, FIG. 4A, FIG. 4B, FIG. 4C, FIG. 5, FIG. 6A, FIG. 6B, and/or FIG. 6C. The method also may include any processes or methods described herein, for example, with respect FIG. 1A, FIG. 1B, FIG. 1C, FIG. 2, FIG. 3A, FIG. 3B, FIG. 3C, FIG. 4A, FIG. 4B, FIG. 4C, FIG. 5, FIG. 6A, FIG. 6B, and/or FIG. 6C.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the examples illustrated and described, and without departing from the spirit and scope of the present invention, which is set forth in the following claims.

What is claimed is:

1. A sealable hatch assembly configured to move between an open condition providing access via an opening to an interior of a compartment on which the sealable hatch assembly is disposed and a closed condition in which the access is sealed, the sealable hatch assembly comprising:
a hatch lid providing a barrier defining a perimeter, an interior side configured to face an interior of the compartment when in the closed condition, and an exterior side opposite the interior side;
an elongated pocket on the interior side of the hatch lid, the elongated pocket at least partially defining a pocket width; and
a seal member received in the elongated pocket, the seal member defining a seal axis and being configured to provide an uninterrupted seal between the hatch lid and a hatch extension coupled to the compartment adjacent the opening, the seal member comprising:
an inner seal portion; and
an outer seal portion at least partially coating the inner seal portion,
the inner seal portion being elastically compressible and the outer seal portion being chemically resistant, and the seal member defining a cross-section perpendicular to the seal axis having an uncompressed dimension greater than the pocket width, such that the seal member is at least partially compressed as received in the elongated pocket.

2. The sealable hatch assembly of claim 1, wherein one or more of the elongated pocket, the seal member, or the hatch extension are configured such that when the hatch lid is in the closed condition, the hatch extension at least partially compresses the seal member in the elongated pocket.

3. The sealable hatch assembly of claim 2, wherein the one or more of the elongated pocket, the seal member, or the hatch extension are configured, such that when the hatch lid is in the closed condition, the hatch lid is configured to seal the opening at a pressure differential ranging from about minus 2 pounds-per-square-inch (psi) to about 2 psi, the pressure differential being indicative of a difference between an interior pressure in the compartment and an exterior pressure on the exterior side of the hatch lid.

4. The sealable hatch assembly of claim 1, wherein the inner seal portion of the seal member comprises one or more of silicones, polysiloxanes, fluoroelastomers, or FKMs.

5. The sealable hatch assembly of claim 1, wherein the inner seal portion of the seal member has a hardness ranging from about Shore 30A to about Shore 80A.

6. The sealable hatch assembly of claim 1, wherein the inner seal portion of the seal member is solid.

7. The sealable hatch assembly of claim 1, wherein the inner seal portion of the seal member defines at least one hollow interior chamber.

8. The sealable hatch assembly of claim 7, wherein the at least one hollow interior chamber extends a length of the seal member.

9. The sealable hatch assembly of claim 1, wherein the outer seal portion comprises one or more of fluorinated ethylene propylene (FEP), polytetrafluoroethylene (PTFE), high-fluorine perfluoroelastomeric compounds, FFKMs, or FKM fluoroelastomers.

10. The sealable hatch assembly of claim 1, wherein the outer seal portion of the seal member is chemically-resistant with respect to one or more of acetic acids, ketones, acetone, hydrochloric acid, petroleum distillates, naphtha, crude oil, kerosene, gasoline, or petroleum-based compounds.

11. The sealable hatch assembly of claim 1, wherein the outer seal portion of the seal member has a hardness ranging from about Shore 20D to about Shore 80D.

12. The sealable hatch assembly of claim 1, wherein the outer seal portion coats at least 50% of an outer surface of the inner seal portion, at least 60% of an outer surface of the inner seal portion, at least 70% of an outer surface of the inner seal portion, at least 80% of an outer surface of the inner seal portion, or at least 90% of an outer surface of the inner seal portion.

13. The sealable hatch assembly of claim 1, wherein the outer seal portion has a maximum thickness ranging from about 0.004 inches to about 0.40 inches.

14. The sealable hatch assembly of claim 1, wherein the cross-section of the seal member is one of circular, oval-shaped, polygonal, rectangular, square, octagonal, or hexagonal.

15. The sealable hatch assembly of claim 1, wherein the seal member is secured in the elongated pocket via one or more of a press-fit, adhesive, or sealant.

16. The sealable hatch assembly of claim 1, wherein a ratio of a difference between the uncompressed dimension of the cross-section of the seal member and the pocket width divided by the uncompressed dimension ranges from about 2% to about 15%, from about 3% to about 12%, from about 4% to about 11%, from about 5% to about 10%, from about 6% to about 9%, or from about 7% to about 8%.

17. The sealable hatch assembly of claim 1, wherein one or more of the hatch lid, the elongated pocket, or the hatch extension is one of substantially circular, substantially-oval shaped, polygonal, square, rectangular, octagonal, or hexagonal.

18. The sealable hatch assembly of claim 1, wherein the elongated pocket at least partially defines a pocket cross-section perpendicular to a longitudinal pocket axis, and the pocket cross-section is one or more of semi-circular, oval-shaped, rectangular, square, octagonal, or hexagonal.

19. The sealable hatch assembly of claim 1, further comprising:
a hinge arm coupled to the hatch lid;
a hinge boss configured to be coupled to the hatch extension; and
a hinge pivot coupling the hinge arm and the hinge boss to one another, such that the hatch lid is pivotable between the closed condition and the open condition.

20. The sealable hatch assembly of claim 1, further comprising:
a clamp retainer coupled to the hatch lid;
a clamp boss configured to be coupled to the hatch extension;
a clamp pivot coupled to the clamp boss and configured to couple the clamp retainer and the clamp boss to one another, such that the clamp pivot is pivotable relative to the clamp boss; and
a clamp tightener engaged with an end of the clamp pivot remote from the clamp boss and configured to:
(i) facilitate increasing a clamping force between the seal member and the hatch extension when the hatch lid is in the closed condition; and
(ii) facilitate separation of the clamp retainer from the clamp pivot when the hatch lid is moved from the closed condition to the open condition.

21. The sealable hatch assembly of claim 20, wherein the clamp retainer at least partially defines a retainer slot configured to receive the end of the clamp pivot remote from the clamp boss.

22. The sealable hatch assembly of claim 20, wherein the end of the clamp pivot remote from the clamp boss includes a threaded portion, and the clamp tightener at least partially defines a threaded aperture configured to receive therein the threaded portion of the clamp pivot.

23. A seal member configured to provide an uninterrupted seal between a hatch lid and a hatch extension adjacent an opening providing access to an interior of a compartment, the hatch lid being configured to be coupled to the hatch extension and to move between an open condition providing access via the opening to the interior of the compartment and a closed condition in which the opening is sealed, the seal member defining a seal axis and comprising:
an inner seal portion; and
an outer seal portion at least partially coating the inner seal portion,
the inner seal portion being elastically compressible and the outer seal portion being chemically resistant, and the seal member defining a cross-section perpendicular to the seal axis having an uncompressed dimension greater than a pocket width of an elongated pocket coupled to the hatch lid and into which the seal member is configured to be received, such that the seal member is at least partially compressed when received in the elongated pocket.

24. The seal member of claim 23, wherein the seal member is configured, such that when the hatch lid is in the closed condition, the hatch extension at least partially compresses the seal member in the elongated pocket.

25. The seal member of claim 24, wherein the seal member is configured, such that when the hatch lid is in the closed condition, the seal member is configured to seal the opening at a pressure differential ranging from about minus 2 pounds-per-square-inch (psi) to about 2 psi, the pressure differential being indicative of a difference between an interior pressure in the compartment and an exterior pressure on the exterior side of the hatch lid.

26. The seal member of claim 23, wherein the inner seal portion of the seal member comprises one or more of silicones, polysiloxanes, fluoroelastomers, or FKMs.

27. The seal member of claim 23, wherein the inner seal portion of the seal member has a hardness ranging from about Shore 30A to about Shore 80A.

28. The seal member of claim 23, wherein the inner seal portion of the seal member is solid.

29. The seal member of claim 23, wherein the inner seal portion of the seal member defines at least one hollow interior chamber.

30. The seal member of claim 29, wherein the at least one hollow interior chamber extends a length of the seal member.

31. The seal member of claim 23, wherein the outer seal portion comprises one or more of fluorinated ethylene propylene (FEP), polytetrafluoroethylene (PTFE), high-fluorine perfluoroelastomeric compounds, FFKMs, or FKM fluoroelastomers.

32. The seal member of claim 23, wherein the outer seal portion of the seal member is chemically-resistant with respect to one or more of acetic acids, ketones, acetone, hydrochloric acid, petroleum distillates, naphtha, crude oil, kerosene, gasoline, or petroleum-based compounds.

33. The seal member of claim 23, wherein the outer seal portion of the seal member has a hardness ranging from about Shore 20D to about Shore 80D.

34. The seal member of claim 23, wherein the outer seal portion coats at least 50% of an outer surface of the inner seal portion, at least 60% of an outer surface of the inner seal portion, at least 70% of an outer surface of the inner seal portion, at least 80% of an outer surface of the inner seal portion, or at least 90% of an outer surface of the inner seal portion.

35. The seal member of claim 23, wherein the outer seal portion has a maximum thickness ranging from about 0.004 inches to about 0.40 inches.

36. The seal member of claim 23, wherein the cross-section of the seal member is one of circular, oval-shaped, polygonal, rectangular, square, octagonal, or hexagonal.

37. The seal member of claim 23, wherein the seal member is configured to be secured in the elongated pocket via one or more of a press-fit, adhesive, or sealant.

38. The seal member of claim 23, wherein a ratio of a difference between the uncompressed dimension of the cross-section of the seal member and the pocket width divided by the uncompressed dimension ranges from about 2% to about 15%, from about 3% to about 12%, from about 4% to about 11%, from about 5% to about 10%, from about 6% to about 9%, or from about 7% to about 8%.

39. The seal member of claim 23, wherein one or more of the hatch lid, the elongated pocket, or the hatch extension is one of substantially circular, substantially-oval shaped, polygonal, square, rectangular, octagonal, or hexagonal.

40. A method for selectively sealing a compartment comprising an opening to an interior of the compartment, the method comprising:
providing a sealable hatch assembly configured to move between an open condition providing access via the opening to the interior of the compartment on which the sealable hatch assembly is disposed and a closed condition in which the opening is sealed, the sealable hatch assembly comprising:
a hatch lid providing a barrier defining a perimeter, an interior side configured to face an interior of the compartment when in the closed condition, and an exterior side opposite the interior side;
an elongated pocket on the interior side of the hatch lid, the elongated pocket at least partially defining a pocket width; and
a seal member received in the elongated pocket, the seal member defining a seal axis and being configured to provide an uninterrupted seal between the hatch lid and a hatch extension coupled to the compartment adjacent the opening, the seal member comprising:
an inner seal portion; and
an outer seal portion at least partially coating the inner seal portion,
the inner seal portion being elastically compressible and the outer seal portion being chemically resistant, and the seal member defining a cross-section perpendicular to the seal axis having an uncompressed dimension greater than the pocket width, such that the seal member is at least partially compressed as received in the elongated pocket.

41. The method of claim 40, wherein one or more of the elongated pocket, the seal member, or the hatch extension are configured such that when the hatch lid is in the closed condition, the hatch extension at least partially compresses the seal member in the elongated pocket.

42. The method of claim 41, wherein the one or more of the elongated pocket, the seal member, or the hatch extension are configured, such that when the hatch lid is in the closed condition, the hatch lid is configured to seal the opening at a pressure differential ranging from about minus 2 pounds-per-square-inch (psi) to about 2 psi, the pressure differential being indicative of a difference between an interior pressure in the compartment and an exterior pressure on the exterior side of the hatch lid.

43. The method of claim 40, wherein the inner seal portion of the seal member comprises one or more of silicones, polysiloxanes, fluoroelastomers, or FKMs.

44. The method of claim 40, wherein the inner seal portion of the seal member has a hardness ranging from about Shore 30A to about Shore 80A.

45. The method of claim 40, wherein the inner seal portion of the seal member is solid.

46. The method of claim 40, wherein the inner seal portion of the seal member defines at least one hollow interior chamber.

47. The method of claim 46, wherein the at least one hollow interior chamber extends a length of the seal member.

48. The method of claim 40, wherein the outer seal portion comprises one or more of fluorinated ethylene propylene (FEP), polytetrafluoroethylene (PTFE), high-fluorine perfluoroelastomeric compounds, FFKMs, or FKM fluoroelastomers.

49. The method of claim 40, wherein the outer seal portion of the seal member is chemically-resistant with respect to one or more of acetic acids, ketones, acetone, hydrochloric acid, petroleum distillates, naphtha, crude oil, kerosene, gasoline, or petroleum-based compounds.

50. The method of claim 40, wherein the outer seal portion of the seal member has a hardness ranging from about Shore 20D to about Shore 80D.

51. The method of claim 40, wherein the outer seal portion coats at least 50% of an outer surface of the inner seal portion, at least 60% of an outer surface of the inner seal portion, at least 70% of an outer surface of the inner seal portion, at least 80% of an outer surface of the inner seal portion, or at least 90% of an outer surface of the inner seal portion.

52. The method of claim 40, wherein the outer seal portion has a maximum thickness ranging from about 0.004 inches to about 0.40 inches.

53. The method of claim 40, wherein the cross-section of the seal member is one of circular, oval-shaped, polygonal, rectangular, square, octagonal, or hexagonal.

54. The method of claim 40, wherein the seal member is secured in the elongated pocket via one or more of a press-fit, adhesive, or sealant.

55. The method of claim 40, wherein a ratio of a difference between the uncompressed dimension of the cross-section of the seal member and the pocket width divided by the uncompressed dimension ranges from about 2% to about 15%, from about 3% to about 12%, from about 4% to about 11%, from about 5% to about 10%, from about 6% to about 9%, or from about 7% to about 8%.

56. The method of claim 40, wherein one or more of the hatch lid, the elongated pocket, or the hatch extension is one of substantially circular, substantially-oval shaped, polygonal, square, rectangular, octagonal, or hexagonal.

57. The method of claim 40, wherein the elongated pocket at least partially defines a pocket cross-section perpendicular to a longitudinal pocket axis, and the pocket cross-section is one or more of semi-circular, oval-shaped, rectangular, square, octagonal, or hexagonal.

58. The method of claim 40, wherein the sealable hatch assembly further comprises:
a hinge arm coupled to the hatch lid;
a hinge boss configured to be coupled to the hatch extension; and
a hinge pivot coupling the hinge arm and the hinge boss to one another, such that the hatch lid is pivotable between the closed condition and the open condition.

59. The method of claim 40, wherein the sealable hatch assembly further comprises:
a clamp retainer coupled to the hatch lid;
a clamp boss configured to be coupled to the hatch extension;
a clamp pivot coupled to the clamp boss and configured to couple the clamp retainer and the clamp boss to one another, such that the clamp pivot is pivotable relative to the clamp boss; and
a clamp tightener engaged with an end of the clamp pivot remote from the clamp boss and configured to:
(i) facilitate increasing a clamping force between the seal member and the hatch extension when the hatch lid is in the closed condition; and
(ii) facilitate separation of the clamp retainer from the clamp pivot when the hatch lid is moved from the closed condition to the open condition.

60. The method of claim 59, wherein the clamp retainer at least partially defines a retainer slot configured to receive the end of the clamp pivot remote from the clamp boss.

61. The method of claim 59, wherein the end of the clamp pivot remote from the clamp boss includes a threaded portion, and the clamp tightener at least partially defines a threaded aperture configured to receive therein the threaded portion of the clamp pivot.
